(19) United States
(12) Patent Application Publication
(10) Pub. No.: US 2021/0003296 A1
(43) Pub. Date: Jan. 7, 2021

(54) METHOD OF INDIRECT EVAPORATIVE COOLING OF AIR AND DEVICE FOR IMPLEMENTATION THEREOF

(71) Applicant: AKCIONERNOE OBSHCHESTVO "GRUPPA MASHINOSTROITEL'NYH ZAVODOV "HIMMASH, Moskva (RU)

(72) Inventors: Murad Maksudovich MAKHMUDOV, Moskva (RU); Evgeniy Vladimirovich KOTOV, Moskva (RU)

(21) Appl. No.: 16/969,311

(22) PCT Filed: Jul. 3, 2018
(86) PCT No.: PCT/RU2018/000438

§ 371 Date: Aug. 12, 2020

(51) Int. Cl. F24F 3/14; F24F 13/30

(52) U.S. Cl. CPC F24F 3/1405; F24F 2110/10; F24F 13/30

(57) ABSTRACT

A group of inventions relates to the field of ventilation and air conditioning by means of indirect evaporative cooling. A method of indirect evaporative cooling of air consists in forming a total air flow upstream of an intake to a heat exchanger, forming a primary flow and a process flow, and regulating the cooling capacity of cooled air from an indirect evaporative cooling device, wherein at the inlet to the heat exchanger the total air flow is divided into a primary flow and a secondary flow so that their throughput capacity can be regulated, the primary flow being directed into the heat exchanger, and the secondary flow being directed into a bypass channel. The primary flow to the heat exchanger is divided into a direct flow and a return flow, having values of hydraulic resistance which are selected to be different.

### CROSS-REFERENCE TO RELATED APPLICATIONS

The present patent application is a National stage application of the PCT application PCT/RU2018/000438 filed Jul. 3, 2018.

### FIELD OF INVENTION

Group of inventions relates to ventilation and air conditioning by indirect evaporative cooling (IEC) method and can be used for providing comfort conditions and indoor microclimate.

IEC is understood to be heat removal from main airflow through the separating heat exchanger plate (wall) to process airflow that is cooling by water evaporation in it. And main air stream is not humidifying during the process.

### BACKGROUND

There is a known method of indirect evaporative cooling and device for its implementation (see RU 2031317, CPC F24F1/02, publ. Mar. 20, 1995). Common airflow passes through dry channels of first section that is in heat exchanging state with wet channels of this section. Outlet airflow is dividing into main and process flows. Process flow is sending in counter direction to the main flow along wetted surfaces of wet channels and after that removing in atmosphere. Main flow passes through dry channels of second section being in heat exchanging state with wet channels of this section and after that transfers to consumer.

However, construction of invention dramatically increases conditioner dimensions. In addition, appliance of two series-arranged wet channels complicates controls adjustment, whose parameters will be depend on current pressure drop in air duct to which conditioner described in patent is connected. Thus, the same conditioner installed in systems with different pressure drops will cause disbalance in degree of control (in %) and valve position (in degrees) relation resulting in manual correction factor adding.

There is a known method of cooling efficiency improving and device for its implementation (see RU 2140044, CPC F24F3/14, publ. Oct. 20, 1999) involving dividing sections of heat exchanger into main airflow section and process airflow section, gas distribution chamber installation to process flow dry channels outlet and gas-dynamic connection of the chamber to wet channels inlets of all sections. That decision provides optimal partitioning of process flow between every channel with minimal aerodynamic and thermal losses, makes main and process flow cooling surfaces area ratio greater or equal than airflows output ratio without increasing pressure drop, improves heat exchange efficiency in wet channels and main airflow cooling rate with reducing its pressure drop. Airflows separating before heat exchanger inlet allows adjusting airflows rate proportion using pressure fans which reduces aerodynamic air pressure drop as there are no airflow controls on outlet connections. Main and process airflows separation before heat exchange sections inlets allows bringing air (gas) into heat exchange sections of main and process airflows with different thermal and humidity parameters which is very important in case of exploitation within system including dehumidifier when extremely dry air may be brought in process flow heat exchange sections with differing thermal and humidity parameters and main flow cooling thermal efficiency will not depends on its humidity. Supplying device with additional water tank piped to main tank and installation of an air-permeable grill dipped in additional water tank allows collecting moisture condensing in main airflow dry channels when using low humidity process flow (for example lower than 5 g/kg dry air) and high humidity main flow (for example 10 g/kg dry air) with it moisture condensed from main flow bringing in the main tank for humidifying capillary porous plates of wet channels.

However existing devise design has no possibility to control cooling capacity.

The most similar method to the claimed group of inventions is air cooling with combined indirect cooling and conditioner to its implementation (RU 2363892, CPC F24F3/14, F24F3/16, F24F11/00, publ. Aug. 10, 2009). According to this method indoor temperature control is carried out through the sensor which impacts the execution mechanism of the valve mounted on a supply cold water pipeline and humidity control is carried out by signal from the sensor impacting air valve execution mechanism which allows adjusting rate proportion of airflows threated in spay chamber and passed through bypass channel whereby one bypass channel end connects to the air conditioner cavity before spray chamber and the other after and indoor air is taking out through air discharging chamber and outlet duct with exhaust deflector which returns part of the recycle air into the mixing chamber.

However indirect cooling control in this method has lack of effectiveness. It should be pointed that airflows mixing in the spray chamber negatively affects microbiological indicators of processed air. Use of water with inconsistent microbiological indicators causes potential bacteria entry in the conditioned air.

### SUMMARY

Technical problem of the group of inventions is the development of effective method for controlling indirect evaporative cooling capacity while maintaining constant airflow rate.

Technical result is enabling to control air temperature at the heat exchanger outlet and consequently the entire indirect evaporative cooling device (conditioner).

Technical problem of the group of inventions is solved by the fact that in the indirect evaporative cooling method, which consists in formation of a common air flow prior to entering the heat exchanger, formation of the main and process flows, controlling cooling capacity of the cooled air from the indirect evaporative cooling device, according to the decision, at the heat exchanger inlet the total air flow is divided into two main and additional ones with possibility of their throughput capacity adjustment, wherein main flow is supplied to heat exchanger, and additional flow is supplied to bypass channel, then main flow in heat exchanger is divided into forward and reverse, values of hydraulic resistances of the main and additional flows are selected equal, additional and direct flows are mixed at the outlet of the heat exchanger, forming a cooled flow at the output of the indirect evaporative cooling device, wherein absolute values of process flow and cooled flow at outlet of device are maintained unchanged.

Device for indirect evaporative cooling, comprising series-arranged air intake section, indirect evaporative cooling heat exchanger and process section, bypass channel, one of ends of which is connected to process section, according to decision, additionally comprises a section of

discharge of process flow, rigidly connected to heat exchanger and located above it, formed as part of reverse cooled main flow, at least one shutter located in front of heat exchanger, bypass channel is equipped with shutter located on the side of air receiving section, to which the other end of bypass channel is connected.

Bypass channel may be located on external surface of the housing of inside the housing.

### BRIEF DESCRIPTION OF THE DRAWINGS

Method is clarifying by figures that represent:

FIG. 1—scheme of cooling capacity control using bypass channel located on external surface of the housing;

FIG. 2—scheme of cooling capacity control using bypass channel located inside the housing;

FIG. 3—plot of cooling capacity versus shutters position for system with two shutters;

FIG. 4—plot of cooling capacity versus shutters position for system with one shutter;

### DRAWING POSITIONS

1—IEC heat exchanger;
2—bypass channel;
3—intake section;
4—process section (mixing chamber);
5—discharge of process flow section;
6—control shutter for bypass channel;
7—shutter before IEC heat exchanger;
8—air handling sections (noise suppression, filtration, humidifying, heating, dehumidification);
9—conditioner frame;
10—water supply unit;
A—common airflow at the conditioner inlet;
B—main airflow supplying to the heat exchanger 1;
C—additional airflow passing through bypass;
D—forward airflow cooled in the heat exchanger 1;
E—process airflow (additional airflow which is humidifying and heating) humidified in the heat exchanger 1 and heated from airflow D;
F—cooled airflow at outlet of the device.

### DETAILED DESCRIPTION OF THE PREFERRED EMBODIMENT

Indirect evaporative cooling device implementing indirect evaporative cooling method comprises of series-arranged intake section 3, air handling sections 8, IEC heat exchanger 1 and bypass channel 2, separated from intake section by shutters 7 and 6 respectively, discharge of process flow section 5, process section (mixing chamber) 4, conditioner frame 9 and water supply unit 10.

Intake air section 3 is placed between air handling sections 8 and IEC heat exchanger 1 provided with at least one shutter 7 located at intake section side. Process section 4 is placed after IEC heat exchanger 1 and serves for mixing flow D passed through IEC heat exchanger 1 with flow C passed through bypass channel 2. Bypass channel 2 is provided with shutter 6 located at intake section side 3. One end of the bypass channel 2 connected with intake section 3 and another with process section 4.

In heat exchanger 1 air is cooling through indirect evaporative cooling, flow D is cooling and bringing to process section 4. In the bypass channel 2 air physical characteristics still unchanged.

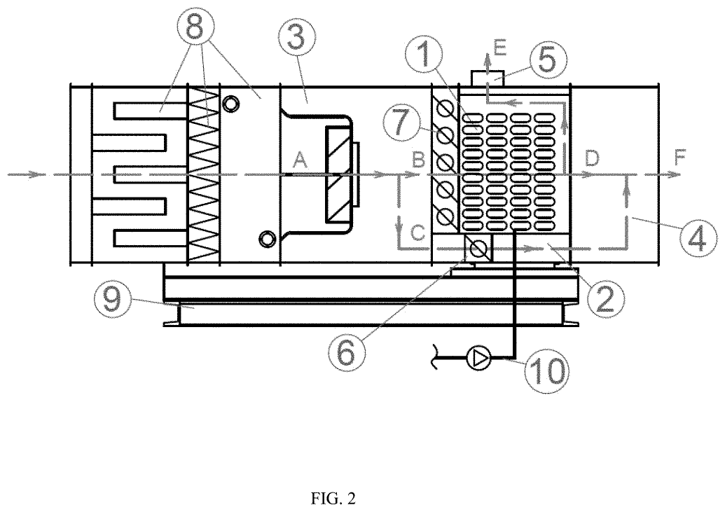

Bypass channel 2 may be located both at external side of the housing (FIG. 2) and inside the housing (FIG. 2).

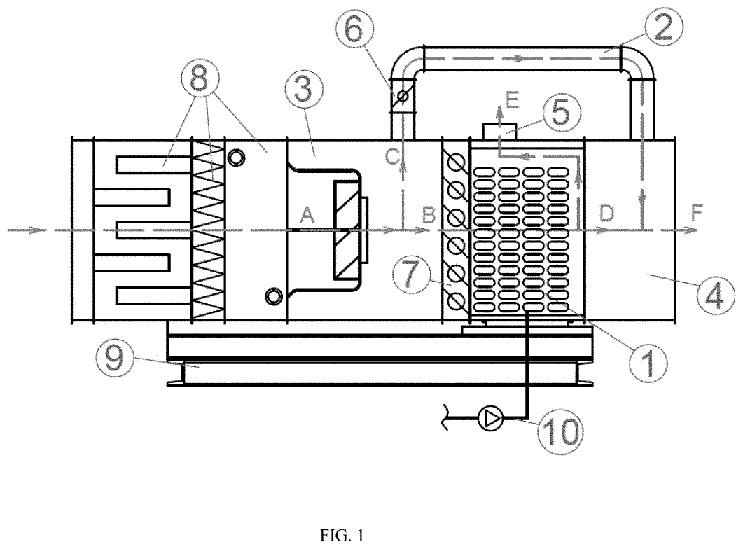

Intake 2 and process 4 section could be both empty sections and equipped sections (air fan etc.) FIG. 1 and FIG. 2 represents layout option with air fan in the intake section 3 and empty process section 4.

Indirect evaporative cooling method is carried out as follows.

Common airflow A at the entry passes through air handling sections 8 and enters to the intake section 3 where separates into flows B and C (by using shutters 6 and 7 respectively) going to the IEC heat exchanger 1 and bypass channel 2.

With two shutters 6 and 7 as system regulators it is possible to control cooling capacity (Qx) in range from 0 to 100% of maximal. With completely closed shutter 6 and opened shutter 7 common airflow A without separation (A=B) fully passes through heat exchanger 1 (maximum cooling capacity). Conversely, with completely opened shutter 6 and closed shutter 7 common airflow A without separation (A=C) fully passes bypass channel 2 (zero cooling capacity).

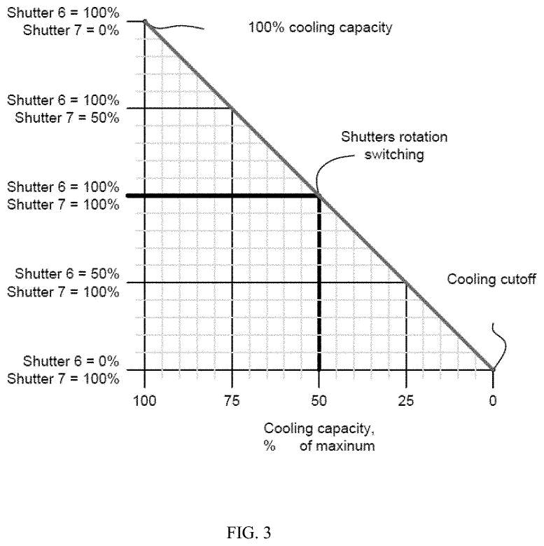

FIG. 3 represents the plot of cooling capacity versus shutters position for system with two shutters 6 and 7, 100% shutter position means complete opening 0% complete closure. Shutters could be implemented as turning gear (rotary, ball), transitional gear (damper), iris gear (iris) or any other type of gear abled to adjust airflow area.

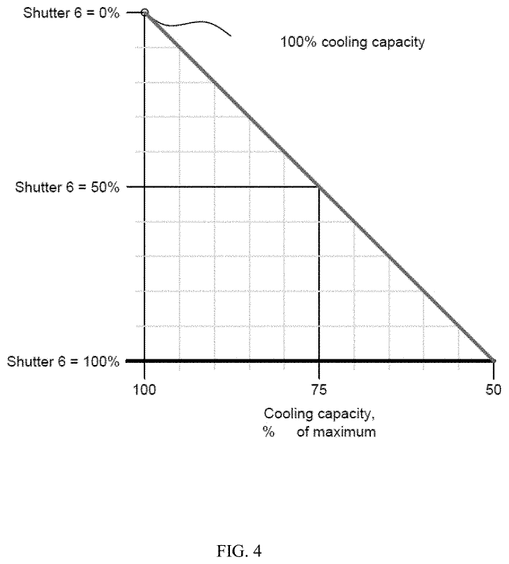

With one shutter 6 placed directly at the border between intake section 3 and bypass channel 2 as system control airflow passes either fully through the IEC heat exchanger 1 (maximum cooling capacity, A=B) or 50/50 through the IEC heat exchanger 1 and bypass channel 2 (50% cooling capacity, A=B+C where B=C). FIG. 4 represents the plot of cooling capacity versus shutters position for system with one shutter 6, 100% shutter position means complete opening 0% complete closure.

In the IEC heat exchanger 1 airflow B separates into cooled flow D which supplies to the mixing chamber 4 and process airflow E which removes outdoor through discharge process flow section 5.

As a result of mixing flows C and D inside the process section (mixing chamber) 4 in different proportion, cooling capacity of cooled airflow F is regulating.

Key factor for keeping constant values of cooled flow F and process flow E rates when cooling capacity regulates by shutter 6 on bypass channel is equality of the IEC heat exchanger 1 and bypass channel 2 hydraulic resistances when air fully passes through the IEC heat exchanger 1 or bypass channel 2. This can be achieved both by reducing bypass channel cross section and by using additional shutter, damper or valve on bypass channel to provide corrective hydraulic resistance.

With decreasing rate of additional airflow main flow B rate decreases proportionally. Due to air passing through bypass channel 2 resistance at the entry of mixing chamber 4 increases for forward flow D, the more shutter 6 opens, the more raise additional airflow C rate increases and the more resistance reduces forward flow D rate. In case resistances of the IEC heat exchanger 1 and bypass channel are equal proportion of flows D and E changes with bypass channel 2 opens (increases for E and decreases for D) but absolute flow rate value remains unchanged, consequently cooled airflow F rate remains unchanged too. Such process takes place throughout all of time shutter 6 opens on the bypass channel.

For further regulation when cooling capacity is under 50% of maximal closure of shutter 7 before IEC heat exchanger is required. Shutter 7 closure leads to IEC heat exchanger 1 resistance increasing, therefore airflows D and E rate decreases. As a flow E is additional, this flow is not much important for air conditioning and its flow rate decreasing will not lead to any aftermaths for cooled air consumers.

The following are examples of claimed group of inventions usage.

Hydraulic resistances of the IEC heat exchanger 1 and bypass channel 2 are considered equal in examples (R1=R2=R).

Tentatively, let the out-conditioner air pressure is equal to atmospheric (at inlet and at flows D and E outlet).

Set the values D=¾ B, E=¼ B.

### Example 1

Shutter 7 is complete open and shutter 6 is closed.

Then cooling capacity equals 100% (Qx=100%) of maximal. Flow A fully passes through the IEC heat exchanger 1.

In this case common airflow A at conditioner inlet will be equal to main flow B passing to the IEC heat exchanger 1. Additional flow C passing through bypass channel is absent.

E=¼B(E=¼ A);

D=¾B(D=¾ A);

F=D(F=¾ A).

### Example 2

Shutter 6 is subopen and shutter 7 is complete open.

With shutter 6 opening airflows separate. Due to resistances R1 and R2 are equal initially with shutter 6 complete open flows will be separated 50/50 of A, with shutter 6 opened up to 10% into bypass channel 2 will pass 10% of 50% of flow A, that is 5% of flow A.

Therefore, main flow B through shutter 7 will be 95% of common flow A and additional flow C through shutter 6 will be 5% of flow A, that is B=0.95 A, a C=0.05 A.

Then, according mathematical logic, follows should occurs:

D=¾B=>D=¾×0.95 A=>D=0.7125 A.

E=¼B=>E=0.2375 A.

F=C+D=0.05 A+0.7125 A=0.7625 A.

Following this logic, initial proportions where flow F=0.75 A became broken.

However, considering the fact that air amount increasing in limited volume will cause increasing pressure inside the volume, it would be clear that throughout capability will decrease for process section (mixing chamber) 4. Air will pass through the path of least resistance and considering that conditioner has two outlets (flows F and E), air will stream from flow F into flow E as flow E has lower resistance.

Air will stream from flow F into flow E until reaches equilibrium state when flow E resistance equals flow F resistance, it means expressions F=¾ AϰE=¼ A will be valid again.

This result is true for any airflow rate changes caused by shutter 6 opening.

When shutter 6 will open completely, cooling capacity reduces to 50% of maximal.

To further cooling capacity reduce shutter 7 closing is required. With shutter 7 closing equation R1=R2 will disbalancing, as shutter 7 will be creating additional resistance for IEC heat exchanger 1 and R1 will exceed R2, therefore airflows F and E rate proportion will change, flow F will grow and flow E will recede.

As the flow E is additional and is not much important for air conditioning and flow F will exceed initial value for consumers, common flow rate correction will be required. This can be achieved by increasing inlet conditioner resistance (by installing shutter for flow F after the conditioner) or by reducing fan airflow, for example by reducing fan speed.

Therein simple and effective indirect evaporative cooling capacity control method with maintaining a constant airflow rate is designed, which allows to control temperature at the outlet of the heat exchanger and consequently of the whole indirect evaporative cooling device.

What is claimed is:

1. An indirect evaporative cooling method, comprising:
formation of a common air flow prior to entering a heat exchanger,
formation of a main and a process flows,
controlling cooling capacity of a cooled air from the indirect evaporative cooling device, and differs in that
the common air flow is separating into main and additional ones with possibility of their throughout capacity adjustment, wherein the main flow is supplied to the heat exchanger and the additional flow is supplied to a bypass channel, then the main flow in the heat exchanger is divided into a forward and a reverse flows, values of hydraulic resistances of the main and the additional flows are selected equal, the additional and the main flows are mixed at an outlet of the heat exchanger, forming a cooled flow at the outlet of the indirect evaporative cooling device, wherein absolute values of the process flow and the cooled flow at the outlet of the device are maintained unchanged.

2. A device for indirect evaporative cooling according claim 1, comprising: a series-arranged air intake section, the indirect evaporative cooling heat exchanger and a process section, the bypass channel, one of ends of which is connected to the process section, differs in that it additionally comprises a section of discharge of the process flow, rigidly connected to the heat exchanger and located above it, formed as a part of the reverse cooled main flow, at least one shutter located in front of the heat exchanger, the bypass channel is equipped with a shutter located on a side of the air receiving section, to which another end of the bypass channel is connected.

3. The device according claim 2, differs in that the bypass channel is located on an external side of a housing.

4. The device according claim 2, differs in that the bypass channel is located inside a housing.
